(19) United States
(12) Patent Application Publication
(10) Pub. No.: US 2023/0324627 A1
(43) Pub. Date: Oct. 12, 2023

(54) FERRULE, OPTICAL CONNECTOR, AND METHOD FOR MANUFACTURING OPTICAL CONNECTOR

(71) Applicants: SUMITOMO ELECTRIC INDUSTRIES, LTD., Osaka-shi, Osaka (JP); NIPPON TSUSHIN DENZAI CO., LTD., Komaki-shi, Aichi (JP)

(72) Inventors: Yuto FUJIHARA, Osaka-shi (JP); Sho YAKABE, Osaka-shi (JP); Dai SASAKI, Osaka-shi (JP); Motoyoshi KIMURA, Komaki-shi (JP); Manabu IZAKI, Komaki-shi (JP)

(73) Assignees: SUMITOMO ELECTRIC INDUSTRIES, LTD., Osaka-shi, Osaka (JP); NIPPON TSUSHIN DENZAI CO., LTD., Komaki-shi, Aichi (JP)

(21) Appl. No.: 18/022,390

(22) PCT Filed: Aug. 25, 2021
(86) PCT No.: PCT/JP2021/031221

§ 371 Date: Feb. 21, 2023

(30) Foreign Application Priority Data
Sep. 25, 2020 (JP) 2020-161249

(51) Int. Cl. G02B 6/38

(52) U.S. Cl. CPC G02B 6/3839; G02B 6/3861

(57) ABSTRACT

A ferrule includes a first end surface and a second end surface, an outer surface, an accommodating part, a plurality of guide grooves, and a first window part and a second window part. The plurality of guide grooves are provided to each extend in the first direction on an inner wall of the accommodating part and be aligned in a second direction intersecting the first direction. The first window part and the second window part open at the outer surface and are connected to each other through the accommodating part. The first window part is positioned on the first end surface side with respect to the second window part. The first window part is provided at a position through which at least a portion of the guide grooves are visually noticeable.

### TECHNICAL FIELD

The present disclosure relates to a ferrule, an optical connector, and a method for manufacturing an optical connector. The present application claims priority based on Japanese Patent Application No. 2020-161249 filed on Sep. 25, 2020, the entire contents of which are incorporated herein by reference.

### BACKGROUND ART

Patent Literature 1 discloses an example of a ferrule that collectively holds a plurality of optical fibers. This ferrule has an opening on one end surface, and a plurality of optical fibers are accommodated inside the ferrule through the opening. There are cases in which a plurality of guide grooves extending in a direction of accommodating the optical fibers are formed on an inner wall of the ferrule. In this case, the optical fibers are accommodated inside the ferrule along the guide grooves. An adhesive is injected into the inside of the ferrule to fix the optical fibers to the guide grooves. Patent Literature 2 to 4 disclose other examples of ferrules.

### CITATION LIST

### Patent Literature

[Patent Literature 1] Japanese Unexamined Patent Publication No. 2006-145787

[Patent Literature 2] Japanese Unexamined Patent Publication No. 2016-184106

[Patent Literature 3] Japanese Unexamined Patent Publication No. 2004-069838

[Patent Literature 4] Japanese Unexamined Patent Publication No. 2005-309009

### SUMMARY OF INVENTION

The present disclosure provides, as one aspect, a ferrule. The ferrule includes a first end surface and a second end surface, an outer surface, an accommodating part, a plurality of guide grooves, and a first window part and a second window part. The first end surface and the second end surface are provided opposite to each other in a first direction. The outer surface is provided between the first end surface and the second end surface. The accommodating part opens at the second end surface and can accommodate a plurality of optical fibers therein. The plurality of guide grooves are configured to determine a position and a direction of each of the plurality of optical fibers in the accommodating part. The plurality of guide grooves are provided to each extend in the first direction on an inner wall of the accommodating part and be aligned in a second direction intersecting the first direction. The first window part and the second window part open at the outer surface and are connected to each other through the accommodating part. The first window part is positioned on the first end surface side with respect to the second window part. The first window part is provided at a position through which at least a portion of the guide grooves are visually noticeable.

The present disclosure provides, as another aspect, an optical connector. The optical connector includes the ferrule described above, a plurality of optical fibers, and an adhesive. The plurality of optical fibers are accommodated in an accommodating part of the ferrule along a plurality of guide grooves. The adhesive is injected into the accommodating part through a first window part to fix the plurality of optical fibers to the inner wall of the accommodating part.

The present disclosure provides, as yet another aspect, a method for manufacturing an optical connector. The method for manufacturing an optical connector includes accommodating a plurality of optical fibers in the accommodating part of the ferrule described above along the plurality of guide grooves, and injecting an adhesive for fixing the plurality of optical fibers to the inner wall of the accommodating part into the accommodating part through the first window part. In the injecting, the adhesive is injected at least up to a region of the accommodating part that is visually noticeable through the second window part.

### BRIEF DESCRIPTION OF DRAWINGS

FIG. 1 is a perspective view illustrating an optical connector according to a first embodiment.

FIG. 2 is a cross-sectional view schematically illustrating a cross section of the optical connector illustrated in FIG. 1 taken along line II-II.

FIG. 3 is a cross-sectional view schematically illustrating a cross section of the optical connector illustrated in FIG. 1 taken along line III-III.

FIG. 4 is a cross-sectional view schematically illustrating a cross section of the optical connector illustrated in FIG. 1 taken along line IV-IV.

FIG. 5 is a cross-sectional view schematically illustrating a cross section of the optical connector in a state in which an adhesive is injected into an accommodating part.

FIG. 6 is a flowchart showing a method for manufacturing an optical connector.

FIG. 7 is a perspective view illustrating an optical connector according to a first modified example.

FIG. 8 is a perspective view illustrating an optical connector according to a second modified example.

FIG. 9 is a perspective view illustrating an optical connector according to a third modified example.

FIG. 10 is a perspective view illustrating an optical connector according to a fourth modified example.

FIG. 11 is a perspective view illustrating an optical connector according to a fifth modified example.

FIG. 12 is a perspective view illustrating an optical connector according to a sixth modified example.

### DESCRIPTION OF EMBODIMENTS

### Object to be Solved by the Present Disclosure

In conventional ferrules that collectively hold a plurality of optical fibers, a width of each guide groove is often small, and a slight deviation in position of the optical fiber may cause the optical fiber to be accommodated in a guide groove different from the guide groove in which it originally should have been accommodated. Also, there is a likelihood that the optical fiber will come into contact with a portion other than the guide groove. In such a case, an operation of accommodating the optical fiber needs to be done again, and there is a likelihood that a distal end portion of the optical fiber may be chipped or disconnected in the process. Particularly, when a polishing treatment is not performed on an end surface of the optical fiber (see Patent Literature 1) or when a lens function is provided on a distal end of the optical fiber (see Patent Literature 2), a length of the distal end portion and a state of the end surface of the optical fiber are important in terms of product performance. Also, when an adhesive is injected into the inside of the ferrule, bubbles may be mixed into the adhesive. If such bubbles are positioned on an optical path of the optical fiber, there is a likelihood that Fresnel loss and deviation of the optical path will occur. Therefore, it is desired to develop a ferrule in which optical fibers can be easily accommodated at appropriate positions in the ferrule and bubbles mixed into the adhesive are easily removed.

### Effects of the Present Disclosure

According to the present disclosure, as one aspect, optical fibers can be easily accommodated at appropriate positions in the ferrule, and bubbles are easily removed from an adhesive injected into the ferrule.

### Description of Embodiments of the Present Disclosure

First, contents of an embodiment of the present disclosure will be listed and described. A ferrule according to one embodiment includes a first end surface and a second end surface, an outer surface, an accommodating part, a plurality of guide grooves, and a first window part and a second window part. The first end surface and the second end surface are provided opposite to each other in a first direction. The outer surface is provided between the first end surface and the second end surface. The accommodating part opens at the second end surface and can accommodate a plurality of optical fibers therein. The plurality of guide grooves are configured to determine a position and a direction of each of the plurality of optical fibers in the accommodating part. The plurality of guide grooves are provided to each extend in the first direction on an inner wall of the accommodating part and be aligned in a second direction intersecting the first direction. The first window part and the second window part open at the outer surface and are connected to each other through the accommodating part. The first window part is positioned on the first end surface side with respect to the second window part. The first window part is provided at a position through which at least a portion of the guide grooves are visually noticeable.

In the ferrule, the first window part and the second window part are provided in the outer surface, and the plurality of guide grooves in the accommodating part are visually noticeable through the first window part. Thereby, the plurality of optical fibers can be easily accommodated at appropriate positions in the ferrule while checking a positional relationship between the plurality of optical fibers and the plurality of guide grooves through the first window part. Also, the first window part is connected to the second window part through the accommodating part. Thereby, for example, when the adhesive for fixing the optical fibers is injected into the accommodating part through the first window part, since air inside the accommodating part is discharged from the second window part, generation of bubbles in the adhesive can be curbed. Further, the first window part is positioned on the first end surface side with respect to the second window part. Thereby, even if bubbles are generated in the adhesive positioned in the vicinity of the distal end of the optical fiber, the bubbles can be removed through the first window part. Therefore, Fresnel loss and deviation of an optical axis due to, for example, bubbles generated on the optical axis of the optical fiber can be prevented.

As one embodiment of the ferrule, the first window part may be provided at a position facing at least a portion of the plurality of guide grooves. According to this aspect, positions and shapes of the plurality of guide grooves can be easily checked through the first window part, and the optical fibers can be easily accommodated at appropriate positions in the guide grooves.

As one embodiment of the ferrule, an opening area of the second window part on the outer surface may be smaller than an opening area of the first window part on the outer surface. The ferrule may be manufactured by, for example, injection molding using a resin as a material. In this case, the resin may shrink when it is cooled to be cured. That is, of the ferrule, a region in which the window part is not provided has a larger amount of resin than a region in which the window part is provided and thus shrinks relatively greatly. On the other hand, according to an aspect described above, since the opening area of the second window part is small, a shrinkage difference between a region in which the second window part is not provided and a region in which the second window part is provided can be made small Therefore, according to the present embodiment, a ferrule having more accurate dimensions can be obtained.

As one embodiment of the ferrule, an opening width of the first window part on the outer surface in the second direction may be larger than a width of a groove region in which the plurality of guide grooves are formed on the inner wall of the accommodating part in the second direction. According to this aspect, even a guide groove positioned at an end portion of the groove region in the second direction is easily visually noticeable through the first window part. That is, positions and shapes of the guide grooves are easily visually noticeable through the first window part, and therefore an operation of accommodating the plurality of optical fibers can be easily performed.

As one embodiment of the ferrule, an opening width of the first window part on the outer surface in the second direction may be larger than an opening width of the first window part on the outer surface in the first direction. According to this aspect, the first window part positioned on the first end surface side is formed to have an opening width that is large in the second direction to be positioned over more guide grooves. That is, positions and shapes of the guide grooves are easily visually noticeable through the first window part, and therefore an operation of accommodating the plurality of optical fibers can be easily performed.

As one embodiment of the ferrule, the opening width in the second direction of the first window part on the outer surface may be 3 mm or more and 10 mm or less. According to this aspect, since the opening width of the first window part in the second direction is 3 mm or more, the plurality of guide grooves are easily visually noticeable through the first window part, and the optical fibers can be easily accommodated at appropriate positions in the ferrule. Since the opening width of the first window part in the second direction is 10 mm or less, a mechanical strength of the ferrule can be kept high even though the first window part is provided.

As one embodiment of the ferrule, at least one of a step and a sloped surface may be formed on an inner wall of the first window part so that an opening area of the first window part on the outer surface is larger than an opening area of the first window part at the inner wall of the accommodating part. According to this aspect, for example, when the adhesive is injected into the accommodating part from the outside of the first window part, it is possible to quickly notice if an amount of the injected adhesive is too much, and thus the adhesive can be prevented from overflowing from the first window part to the outside of the ferrule.

As one embodiment of the ferrule, the second window part may include a plurality of window parts opening at the outer surface and connected to the accommodating part. According to this aspect, even if this causes bubbles to be generated when the plurality of optical fibers are fixed with the adhesive, bubbles are easily removed through the plurality of second window parts.

As one embodiment of the ferrule, the ferrule may further include a plurality of through holes, into which distal ends of the optical fibers can be inserted, provided to extend in the first direction to expose one ends thereof at the first end surface and be aligned in the second direction, in which the plurality of through holes may be positioned between the first window part and the first end surface in the first direction. According to this aspect, since the distal ends of the optical fibers are held by the plurality of through holes, a positional deviation of the optical fibers is suppressed. That is, a deviation of an optical axis of each of the optical fibers can be prevented.

An optical connector according to one embodiment includes any one of the ferrules described above, a plurality of optical fibers, and an adhesive. The plurality of optical fibers are accommodated in the accommodating part of the ferrule along the plurality of guide grooves. The adhesive is injected into the accommodating part through the first window part to fix the plurality of optical fibers to the inner wall of the accommodating part.

In this optical connector, the plurality of optical fibers can be easily accommodated at appropriate positions in the ferrule while checking positions of the plurality of guide grooves through the first window part. Also, since the plurality of optical fibers are fixed to the inner wall of the accommodating part by the adhesive, a positional deviation of the optical fibers is prevented. Further, even if bubbles are generated inside the adhesive, the bubbles can be easily removed through both the first window part and the second window part.

As one embodiment of the optical connector, the optical connector may further include a pressing part positioned inside the first window part and configured to press the plurality of optical fibers toward the plurality of guide. According to this aspect, since floating of the optical fibers from the guide grooves is suppressed by the pressing part, a positional deviation of the optical fibers can be prevented.

A method for manufacturing an optical connector according to one embodiment is a method for manufacturing an optical connector having any one of the ferrules described above, and includes accommodating a plurality of optical fibers in the accommodating part of the ferrule along the plurality of guide grooves, and injecting an adhesive for fixing the plurality of optical fibers to the inner wall of the accommodating part into the accommodating part through the first window part. In the injecting, the adhesive is injected at least up to a region of the accommodating part that is visually noticeable through the second window part.

In the method for manufacturing an optical connector, when the adhesive is injected into the accommodating part through the first window part, air in the accommodating part is discharged from the second window part. Thereby, generation of bubbles in the adhesive can be curbed. Also, the adhesive is injected up to a region of the accommodating part that is visually noticeable through the second window part. Thereby, since the plurality of optical fibers are fixed to the inner wall of the accommodating part, the plurality of optical fibers can be prevented from falling off from the ferrule.

### Detailed Description of Embodiments of the Present Disclosure

Specific examples of a ferrule, an optical connector, and a method for manufacturing an optical connector according to one embodiment of the present disclosure will be described below with reference to the drawings. The present disclosure is not limited to these examples but is indicated by the scope of the claims, and is intended to include meanings equivalent to the claims and all modifications within the scope. In the description of the drawings, the same elements will be denoted by the same reference signs, and duplicate description thereof will be omitted.

### FIRST EMBODIMENT

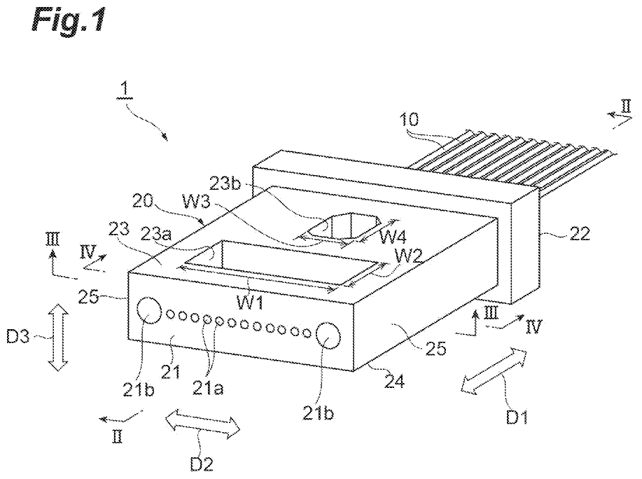

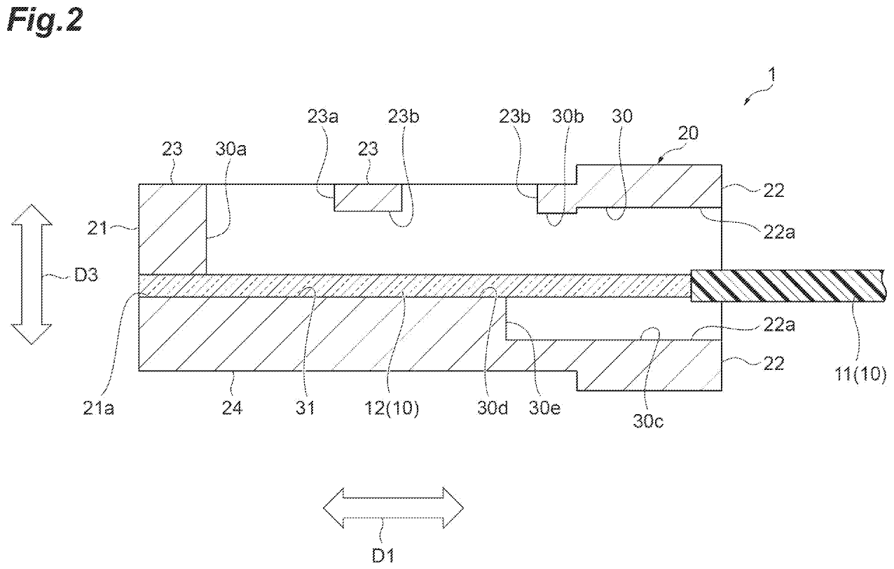

A configuration of an optical connector 1 according to a first embodiment will be described with reference to FIGS. 1 and 2. FIG. 1 is a perspective view illustrating the optical connector 1 according to the first embodiment. FIG. 2 is a cross-sectional view schematically illustrating a cross section of the optical connector 1 illustrated in FIG. 1 taken along line II-II. Hereinafter, for the sake of explanation, a longitudinal direction of a ferrule 20 is referred to as a direction D1 (first direction), a transverse direction of the ferrule 20 is referred to as a direction D2 (second direction), and a thickness direction of the ferrule 20 is referred to as a direction D3.

The optical connector 1 includes a plurality of optical fibers 10 and the ferrule 20. Each of the optical fibers 10 is a member for transmitting an optical signal. The optical fibers 10 are provided to extend in the direction D1 and be aligned in the direction D2 intersecting the direction D1 (perpendicularly in the present embodiment). In the present embodiment, the number of the optical fibers 10 is, for example, twelve in total, but the number of the optical fibers 10 is not limited thereto, and may be, for example, four, eight, twenty-four, or the like. As illustrated in FIG. 2, each of the optical fibers 10 includes a coated portion 11 and a coating-removed portion 12 positioned on a distal end side of the optical fiber 10 with respect to the coated portion 11. The coated portion 11 is a portion in which a coating resin is coated around a clad. The coating-removed portion 12 is a portion from which the coating resin around the clad has been removed. The plurality of optical fibers 10 are accommodated in an internal space (accommodating part 30) of the ferrule 20 through an opening 22a provided at a second end surface 22 of the ferrule 20. In the present embodiment, as an example, the entire coating-removed portion 12 and an end portion of the coated portion 11 are accommodated in the accommodating part 30.

The ferrule 20 is a part that holds end portions of the plurality of optical fibers 10, and may be, for example, an MT ferrule. The ferrule 20 has an appearance in a substantially rectangular parallelepiped shape. The ferrule 20 is formed of, for example, a resin. The ferrule 20 includes a first end surface 21, the second end surface 22, an upper surface (outer surface) 23, a lower surface 24, a pair of side surfaces 25, the accommodating part 30, and a plurality of guide grooves 31.

As illustrated in FIG. 1, the first end surface 21 is an end surface provided at a distal end of the ferrule 20 and extends in the direction D2 and the direction D3. The first end surface 21 is opposite to the second end surface 22 in the direction D 1. The first end surface 21 has a plurality of through holes 21a and a pair of guide holes 21b. Each of the through holes 21a is a hole formed in the direction D1 from the first end surface 21 toward the second end surface 22. The through holes 21a are aligned in the direction D2. The number of the through holes 21a is the same as or larger than the number of the plurality of optical fibers 10 accommodated in the ferrule 20. As illustrated in FIG. 2, the through holes 21a are positioned between a first window part 23a provided at the upper surface 23 of the ferrule 20 and the first end surface 21 in the direction D1. One end of each of the through holes 21a is exposed to the outside of the ferrule 20 at the first end surface 21. On the other hand, the other end of each through hole 21a is connected to the accommodating part 30 at a distal end side inner surface 30a of the accommodating part 30. Each through hole 21a is configured to have an inner diameter larger than an outer diameter of the coating-removed portion 12 of each of the optical fibers 10. Thereby, distal end portions of the plurality of coating-removed portions 12 can be inserted into the inside of the plurality of through holes 21a.

Further, the ferrule 20 may not necessarily have to have the through holes 21a. In this case, a distal end surface of each optical fiber 10 accommodated in the accommodating part 30 comes into contact with the distal end side inner surface 30a of the accommodating part 30. Also, the ferrule 20 is formed of a light-transmitting resin, and light emitted from each optical fiber 10 can transmit between the distal end side inner surface 30a and the first end surface 21. Also, the first end surface 21 may have a plurality of lenses at positions overlapping optical axes of the plurality of optical fibers 10. In this case, light emitted from each optical fiber 10 is collimated by each lens and then is incident on an optical fiber on the opposite side.

The pair of guide holes 21b are holes formed from the first end surface 21 toward the second end surface 22. The pair of guide holes 21b are provided at both ends of the first end surface 21 in the direction D1. The guide holes 21b may be non-through holes having bottom surfaces, or may be through holes penetrating from the first end surface 21 to the second end surface 22. One end of a guide pin (not illustrated) having, for example, a columnar outer shape is inserted into each of the guide holes 21b. The other end of the guide pin is inserted into a guide hole similarly formed in a ferrule on the opposite side. Positioning of the ferrules using the guide pins can be performed by the guide holes.

The second end surface 22 is a surface opposite to the first end surface 21 in the direction D1 and extends in the direction D2 and the direction D3. As illustrated in FIG. 2, the second end surface 22 has an opening 22a. The opening 22a is connected to the accommodating part 30, and end portions of the optical fibers 10 are accommodated in the accommodating part 30 through the opening 22a.

The upper surface (outer surface) 23 is a surface provided between the first end surface 21 and the second end surface 22, and extends in the direction D1 and the direction D2. The upper surface 23 is opposite to the lower surface 24 in the direction D3. Hereinafter, a side in which the upper surface 23 is positioned in the direction D3 is referred to as an upper side of the ferrule 20, and a side in which the lower surface 24 is positioned is referred to as a lower side of the ferrule 20. The first window part 23a and a second window part 23b are provided at the upper surface 23. As illustrated in FIG. 2, the first window part 23a and the second window part 23b open at the upper surface 23 and an upper inner surface 30b of the accommodating part 30. Also, the first window part 23a and the second window part 23b are connected to each other through the accommodating part 30.

As illustrated in FIG. 1, the first window part 23a is provided on the first end surface 21 side with respect to the second window part 23b in the direction D1. The first window part 23a is formed to have a rectangular cross-sectional shape when it is taken along a plane in the direction D1 and the direction D2. On the other hand, the second window part 23b is formed to have a substantially rectangular cross-sectional shape when it is taken along a plane in the direction D1 and the direction D2, but differs from the first window part 23a in that four corners thereof are chamfered. Further, in the present embodiment, only the four corners of the second window part 23b are chamfered, but the four corners of the first window part 23a may also be chamfered. Also, both the four corners of the first window part 23a and the four corners of the second window part 23b may not be chamfered.

The first window part 23a has an opening width W1 in the direction D2 and an opening width W2 in the direction D1. Also, the second window part 23b has an opening width W3 in the direction D2 and an opening width W4 in the direction D1. Here, the opening width refers to a maximum width of the opening of the window part. That is, in a case of the second window part 23b in which the four corners are chamfered, a width of the opening measured at a portion in which chamfering is not performed is the opening width W3 or the opening width W4. In the present embodiment, the opening width W1 of the first window part 23a is larger than the opening width W2, and the opening width W3 of the second window part 23b is smaller than the opening width W4. Also, the opening width W1 of the first window part 23a is larger than the opening width W3 of the second window part 23b. Further, a magnitude relation between the opening width W1 and the opening width W2 of the first window part 23a and the opening width W3 and the opening width W4 of the second window part 23b is not limited to the above-described example. For example, the opening width W1 of the first window part 23a may be smaller than the opening width W2 of the first window part 23a. Also, the opening width W1 of the first window part 23a may be smaller than the opening width W3 of the second window part 23b. As an example, sizes of the opening width W1 and the opening width W2 of the first window part 23a and the opening width W3 and the opening width W4 of the second window part 23b are each 1 mm or more and 10 mm or less. Also, the first window part 23a is formed so that an opening area on the upper surface 23 is larger than an opening area of the second window part 23b. Here, the opening area refers to an area of a region occupied by the opening on a surface on which the opening is provided. Further, the opening area of the first window part 23a may be the same size as the opening area of the second window part 23b, or may be smaller than the opening area of the second window part 23b.

The lower surface 24 is a surface provided between the first end surface 21 and the second end surface 22, and extends in the direction D1 and the direction D2. The lower surface 24 is opposite to the upper surface 23 in the direction D3. As illustrated in FIG. 1, the pair of side surfaces 25 are surfaces provided between the first end surface 21 and the second end surface 22, and extend in the direction D1 and the direction D3. The pair of side surfaces 25 are opposite to each other in the direction D2.

The accommodating part 30 is an internal space of the ferrule 20 and can accommodate end portions of the plurality of optical fibers 10. As illustrated in FIG. 2, the inner wall defining the accommodating part 30 has the distal end side inner surface 30a, the upper inner surface 30b, a lower inner surface 30c, and a fiber support surface 30d.

The distal end side inner surface 30a is a surface positioned on a rear side of the first end surface 21 as described above, and extends in the direction D2 and the direction D3. The distal end side inner surface 30a has openings of the plurality of through holes 21a. The upper inner surface 30b is a surface positioned on a rear side of the upper surface 23, and extends in the direction D1 and the direction D2. The upper inner surface 30b has the opening of the first window part 23a and the opening of the second window part 23b. The lower inner surface 30c and the fiber support surface 30d are surfaces positioned on a rear side of the lower surface 24, and extend in the direction D1 and the direction D2. Also, the lower inner surface 30c and the fiber support surface 30d face the upper inner surface 30b in the direction D3. The lower inner surface 30c is positioned on the second end surface 22 side with respect to the fiber support surface 30d. An end portion of the lower inner surface 30c on the first end surface 21 side is connected to an end portion of the fiber support surface 30d on the second end surface 22 side by a step 30e. Thereby, the lower inner surface 30c is positioned on a lower side with respect to the fiber support surface 30d. A separation distance from the upper inner surface 30b to the lower inner surface 30c is larger than a separation distance from the upper inner surface 30b to the fiber support surface 30d. Therefore, since the opening 22a can be formed to be large, the optical fibers 10 can be easily accommodated in the accommodating part 30 through the opening 22a. Also, since the distance between the upper inner surface 30b and the fiber support surface 30d is small on the first end surface 21 side, movement of the optical fibers 10 in the direction D3 is restricted, and positioning of the optical fibers 10 can be facilitated.

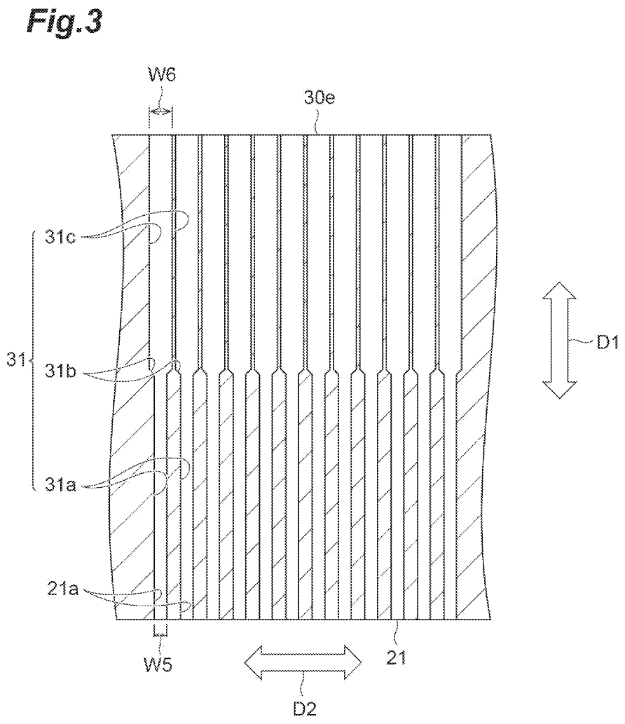

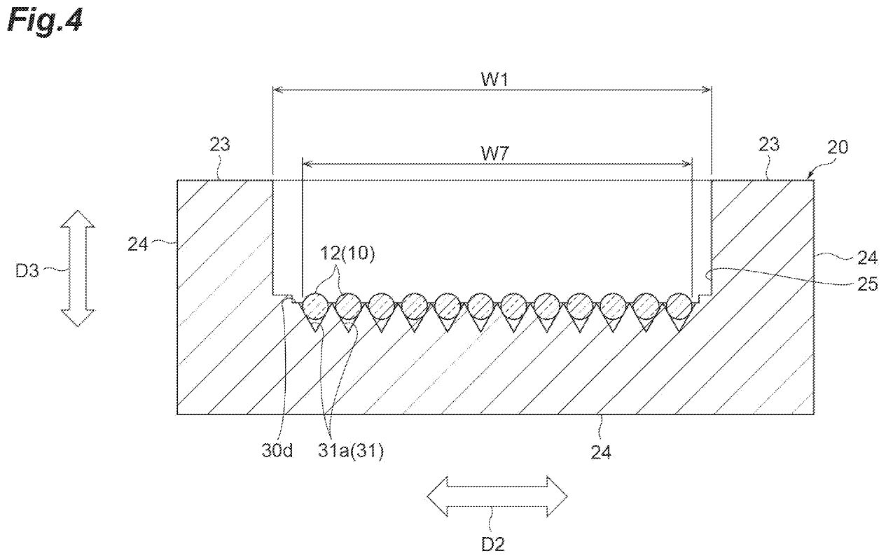

The fiber support surface 30d has the plurality of guide grooves 31 on which the plurality of optical fibers 10 are disposed. The plurality of guide grooves 31 are used to determine positions and directions of the plurality of optical fibers 10 in the accommodating part 30. Here, a configuration of the guide groove 31 will be described with reference to FIGS. 3 and 4. FIG. 3 is a view schematically illustrating a part of a cross section of the optical connector 1 illustrated in FIG. 1 taken along line III-III. That is, FIG. 3 is a cross-sectional view of the guide groove 31 taken along a plane in the direction D1 and the direction D2 (a plane parallel to the upper surface 23). Further, illustration of the plurality of optical fibers 10 is omitted in FIG. 3 for explanation. FIG. 4 is a view schematically illustrating a cross section of the optical connector 1 illustrated in FIG. 1 taken along line IV-IV. That is, FIG. 4 is a cross-sectional view of the optical connector 1 taken along a plane in the direction D2 and the direction D3 (a plane parallel to the first end surface 21) at a position at which the first window part 23a is provided.

As illustrated in FIG. 3, each guide groove 31 is a groove extending in the direction D1. The guide grooves 31 are provided to be aligned in the direction D2. The guide grooves 31 are formed in the same number as the number of the through holes 21a, and 12 guide grooves 31 are formed in the present embodiment.

Each of the guide grooves 31 includes a first guide groove 31a (first portion), a tapered groove 31b, and a second guide groove 31c (second portion) in order from the first end surface 21 side in the direction D1. One end of the first guide groove 31a is continuous with the through hole 21a, and the other end is continuous with the tapered groove 31b. A width W5 of the first guide groove 31a in the direction D2 is smaller than a width W6 of the second guide groove 31c. Thereby, a position of the optical fiber 10 is roughly aligned in the second guide groove 31c, and then the position of the optical fiber 10 can be aligned in the first guide groove 31a with high accuracy. The tapered groove 31b is a groove connecting the first guide groove 31a and the second guide groove 31c, and is formed such that a width in the direction D2 gradually decreases toward the first guide groove 31a side. The optical fiber 10 can be smoothly moved from the second guide groove 31c to the first guide groove 31a by the tapered groove 31b. One end of the second guide groove 31c is continuous with the tapered groove 31b, and the other end opens at a surface of the step 30e. A distal end of the optical fiber 10 is accommodated in the second guide groove 31c from an opening of the second guide groove 31c provided at the step 30e, and is inserted into the through hole 21a through the tapered groove 31b and the first guide groove 31a.

Further, a shape of the guide groove 31 is not limited to that described above. For example, the guide groove 31 may be a straight groove having a constant width in the direction D2 (the widths W5 and W6 are equal to each other). Also, the guide groove 31 may not be formed to be continuous in the direction D1. Specifically, a plurality of groove parts extending in the direction D1 may be provided to be spaced apart. Also, the opening of the second guide groove 31c at the step 30e may have a taper to facilitate introduction of the optical fiber 10.

As illustrated in FIG. 4, the first guide groove 31a is a V-groove with a sharp bottom portion recessed from the fiber support surface 30d toward the lower surface 24. That is, a pair of inner walls defining the first guide groove 31a are inclined with respect to the fiber support surface 30d and connected at the bottom portion of the first guide groove 31a. A width of the first guide groove 31a in the direction D2 becomes smaller toward the bottom portion. Thereby, the coating-removed portion 12 of the optical fiber 10 accommodated in the first guide groove 31a is held to be sandwiched between the inner walls of the first guide groove 31a. A positional deviation of the optical fiber 10 in the direction D2 is prevented by the first guide groove 31a. Further, a shape of the first guide groove 31a is not limited to the V groove, and may be, for example, a U groove in which a bottom portion thereof has a roundish shape, or a rectangular groove having a bottom surface extending in the direction D1 and the direction D2. Further, of the guide groove 31, the cross section of the first guide groove 31a has been described above as an example, but the second guide groove 31c may also have the same cross-sectional shape as the first guide groove 31a.

Next, a positional relationship between the plurality of guide grooves 31, and the first window part 23a and the second window part 23b will be described. As illustrated in FIG. 2, the first window part 23a and the second window part 23b are provided at positions facing the fiber support surface 30d. Specifically, the first window part 23a is provided at a position facing the plurality of first guide grooves 31a, and thus at least a portion of the plurality of first guide grooves 31a are visually noticeable through the first window part 23a. Further, it is preferable that the first window part 23a be provided at a position through which connection portions between the first guide grooves 31a and the through holes 21a are visually noticeable. Thereby, since a position of the opening of each through hole 21a can be checked through the first window part 23a, each optical fiber 10 can be easily inserted into each through hole 21a. Also, as illustrated in FIG. 4, the first window part 23a is formed such that the opening width W1 in the direction D2 is larger than a width W7 of a groove region in which the plurality of guide grooves 31 are formed. Thereby, end portions of all the first guide grooves 31a on the first end surface 21 side are visually noticeable through the first window part 23a.

As illustrated in FIG. 2, the second window part 23b is provided at a position facing the plurality of second guide grooves 31c, and thus at least a portion of the plurality of second guide grooves 31c are visually noticeable through the second window part 23b. The second window part 23b is preferably provided at a position through which end portions (openings of the second guide grooves 31c at the step 30e) of the second guide grooves 31c on the second end surface 22 side are visually noticeable. Thereby, since positions of the openings of the second guide grooves 31c can be checked through the second window part 23b, the optical fibers 10 can be easily accommodated in the second guide grooves 31c. Further, the first window part 23a and the second window part 23b need only be provided at positions through which at least a portion of the plurality of guide grooves 31 are visually noticeable, and are not necessarily provided at positions facing the plurality of guide grooves 31. For example, the second window part 23b may be provided at a position facing the lower inner surface 30c (a position in the vicinity of the second end surface 22).

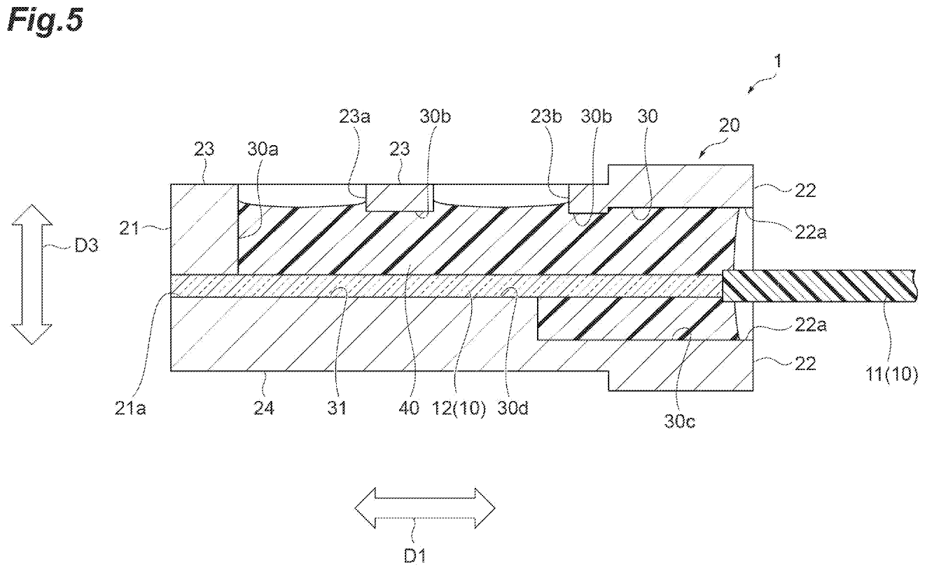

FIG. 5 is a view schematically illustrating a cross section of the optical connector 1 in a state in which an adhesive 40 is injected into the accommodating part 30. As illustrated in FIG. 5, the optical connector 1 includes the adhesive 40 that fixes the plurality of optical fibers 10 to an inner wall of the accommodating part 30. The adhesive 40 is injected into the accommodating part 30 through the first window part 23a in a state in which the plurality of optical fibers 10 are accommodated in the accommodating part 30. In the present embodiment, the injected adhesive 40 moves toward the opening 22a side of the second end surface 22 and reaches a position at which it covers a part of the coated portion 11 of the optical fiber 10. Also, the adhesive 40 is injected until it reaches the inside of the first window part 23a and the second window part 23b. The adhesive 40 may enter, for example, a gap between the guide groove 31 and the coating-removed portion 12 of the optical fiber 10. Further, the adhesive 40 need only be injected by an amount capable of fixing the plurality of optical fibers 10 to the accommodating part 30, and does not necessarily have to fill the entire region of the accommodating part 30. For example, the adhesive 40 may be provided only on the fiber support surface 30d.

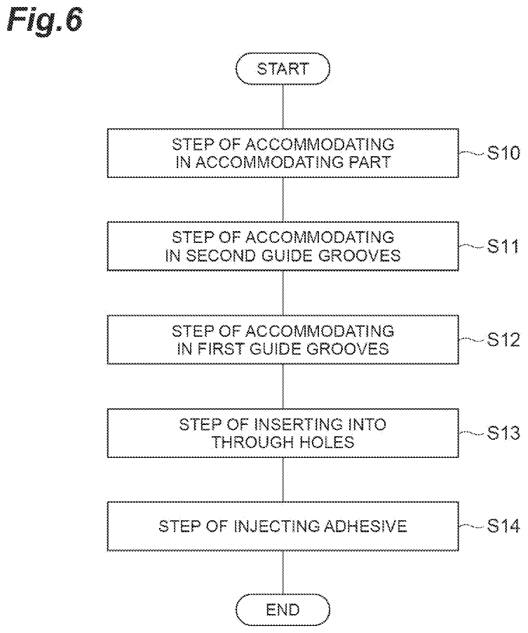

FIG. 6 is a flowchart showing a method for manufacturing the optical connector 1. A method for manufacturing the optical connector 1 described above will be described with reference to FIG. 6. First, distal ends of the plurality of optical fibers 10 are accommodated in the accommodating part 30 through the opening 22a of the ferrule 20 (step S10) (see FIG. 2).

Next, the distal ends of the optical fibers 10 are accommodated in the plurality of second guide grooves 31c (step S11). Then, the plurality of optical fibers 10 are moved to the tapered grooves 31b along the second guide grooves 31c. At this time, operations of accommodating and moving the optical fibers 10 may be performed while checking positions, shapes, and the like of the plurality of second guide grooves 31c through the second window part 23b of the ferrule 20.

Next, the distal ends of the optical fibers 10 are accommodated in the plurality of first guide grooves 31a through the tapered grooves 31b (step S12). Then, the distal ends of the plurality of optical fibers 10 are moved to the through holes 21a side along the first guide grooves 31a. At this time, an operation of moving the optical fibers 10 may be performed while checking positions, shapes, and the like of the plurality of first guide grooves 31a through the first window part 23a of the ferrule 20.

Thereafter, the distal ends of the optical fibers 10 are inserted into the plurality of through holes 21a (step S13). At this time, an operation of inserting the optical fibers 10 may be performed while checking positions, shapes, and the like of the plurality of optical fibers 10 and the plurality of through holes 21a through the first window part 23a of the ferrule 20.

Next, the adhesive 40 is injected into the accommodating part 30 (step S14). At this time, the adhesive 40 may be injected into the accommodating part 30 through the first window part 23a of the ferrule 20 (see FIG. 5). Also, the injected adhesive 40 may move to the second end surface 22 side to reach a position at which it covers the end portion of the coated portion 11 of each of the optical fibers 10. As described above, the manufacturing process of the optical connector 1 ends.

As described above, in the ferrule 20, the optical connector 1, and the method for manufacturing the optical connector 1 according to the present embodiment, the plurality of optical fibers 10 can be easily accommodated at appropriate positions in the ferrule 20 while checking a positional relationship between the plurality of optical fibers 10 and the plurality of guide grooves 31 through the first window part 23a. Also, the first window part 23a is connected to the second window part 23b through the accommodating part. Thereby, for example, when the adhesive 40 for fixing the optical fibers is injected into the accommodating part 30 through the first window part 23a, since air inside the accommodating part 30 is discharged from the second window part 23b, generation of bubbles in the adhesive 40 can be curbed. Further, the first window part 23a is positioned on the first end surface 21 side with respect to the second window part 23b. Thereby, even if bubbles are generated in the adhesive 40 positioned in the vicinity of the distal end of the optical fiber 10, the bubbles can be removed from the first window part 23a. Therefore, Fresnel loss and deviation of an optical axis due to, for example, bubbles generated on the optical axis of the optical fiber 10 can be prevented.

In the above-described embodiment, the first window part 23a is provided at a position facing at least a portion of the plurality of guide grooves 31. Thereby, it easy to check positions and shapes of the plurality of guide grooves 31 through the first window part 23a, and the optical fibers 10 can be more easily accommodated at appropriate positions of the guide grooves 31.

In the above-described embodiment, the opening area of the second window part 23b on the upper surface 23 (outer surface) is smaller than the opening area of the first window part 23a on the upper surface 23. The ferrule 20 may be manufactured by, for example, injection molding using a resin as a material. In this case, the resin may shrink when it is cooled to be cured. That is, of the ferrule 20, a region in which the window part is not provided has a larger amount of resin than a region in which the window part is provided, and thus shrinks relatively greatly. On the other hand, according to an aspect described above in which the opening area of the second window part 23b is small, a shrinkage difference between a region in which the second window part 23b is not provided and a region in which the second window part 23b is provided can be made small Therefore, according to the present embodiment, a ferrule having more accurate dimensions can be obtained.

In the above-described embodiment, the opening width W1 of the first window part 23a on the upper surface 23 in the direction D2 is larger than the width W7 of a groove region in which the plurality of guide grooves 31 are formed in the direction D2. Thereby, for example, even the guide groove 31 positioned at an end portion of the groove region in the direction D2 is easily visually noticeable through the first window part 23a. That is, positions and shapes of the guide grooves 31 are easily visually noticeable through the first window part 23a, and therefore an operation of accommodating the plurality of optical fibers 10 can be easily performed.

In the above-described embodiment, the opening width W1 of the first window part 23a on the upper surface 23 in the direction D2 is larger than the opening width W2 of the first window part 23a in the direction D1. Thereby, the first window part 23a positioned on the first end surface 21 side is formed to have the opening width W1 that is large in the direction D2 to be positioned over more optical fibers 10. That is, positions and shapes of the guide grooves 31 are easily visually noticeable through the first window part 23a, and therefore an operation of accommodating the plurality of optical fibers 10 can be easily performed.

In the above-described embodiment, the opening width W1 in the direction D2 of the first window part 23a on the upper surface 23 is, for example, 3 mm or more and 10 mm or less. Accordingly, since the opening width W1 of the first window part 23a in the direction D2 is 3 mm or more, the plurality of guide grooves 31 are easily visually noticeable through the first window part 23a, and the optical fibers 10 can be easily accommodated at appropriate positions in the ferrule 20. Also, since the opening width W1 of the first window part 23a in the direction D2 is 10 mm or less, a mechanical strength of the ferrule 20 can be kept high even though the first window part 23a is provided.

In the above-described embodiment, the ferrule 20 includes the plurality of through holes 21a, into which distal ends of the optical fibers 10 can be inserted, provided to extend in the direction D1 to expose one ends thereof at the first end surface 21 and be aligned in the direction D2. Also, the plurality of through holes 21a are positioned between the first window part 23a and the first end surface 21 in the direction D 1. Thereby, since the distal ends of the optical fibers 10 are held by the plurality of through holes 21a, a positional deviation of the optical fibers 10 is suppressed. That is, a deviation of an optical axis of each of the optical fibers 10 can be prevented.

### FIRST MODIFIED EXAMPLE

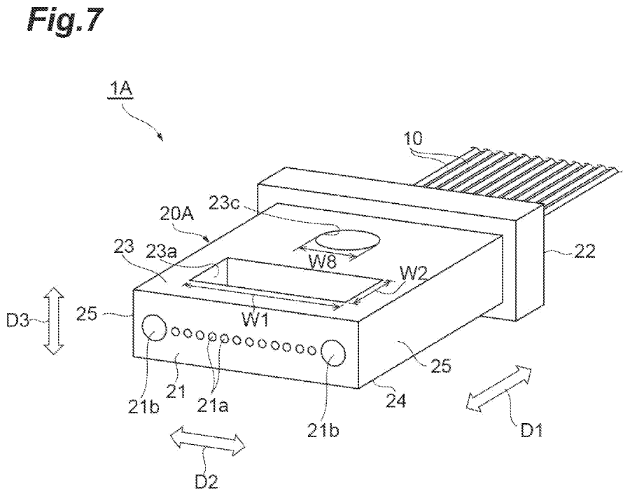

A first modified example of the optical connector 1 will be described with reference to FIG. 7. FIG. 7 is a perspective view illustrating an optical connector 1A according to the first modified example. In the following description, differences from the optical connector 1 according to the first embodiment described above in detail using FIGS. 1 to 4 will be mainly described, and description of common points may be omitted.

The optical connector 1A according to the first modified example includes a plurality of optical fibers 10 and a ferrule 20A that holds the plurality of optical fibers 10. The ferrule 20A includes a first window part 23a and a second window part 23c in an upper surface 23 thereof The first window part 23a according to the first modified example has the same configuration as the first window part 23a according to the first embodiment described above. On the other hand, the second window part 23c according to the first modified example has a shape different from that of the first window part 23a according to the first embodiment.

The second window part 23c according to the first modified example is formed to have a circular cross-sectional shape when it is taken along a plane in a direction D1 and a direction D2. That is, an inner wall of the second window part 23c forms a columnar surface. The second window part 23c is formed such that a diameter W8 of the opening on the upper surface 23 is smaller than an opening width W1 of the first window part 23a. For example, the diameter W8 of the second window part 23c may be half or less of the opening width W1 of the first window part 23a. Further, as in the second window part 23b according to the first embodiment, the second window part 23c according to the present modified example is connected to the first window part 23a through an accommodating part 30 inside the ferrule 20A. Also, the second window part 23c is formed at a position facing a plurality of guide grooves 31 (particularly, a plurality of second guide grooves 31c) provided on a fiber support surface 30d of the accommodating part 30, and thus at least a portion of the plurality of guide grooves 31 are visually noticeable through the second window part 23c.

In the optical connector 1A according to the present modified example, positions and shapes of the plurality of guide grooves 31 can be checked through the first window part 23a and the second window part 23c. Thereby, the plurality of optical fibers 10 can be easily accommodated at appropriate positions in the ferrule 20A. Also, the first window part 23a is connected to the second window part 23c via the accommodating part. Thereby, for example, when an adhesive 40 for fixing the optical fibers is injected into the accommodating part 30 through the first window part 23a, since air inside the accommodating part 30 is discharged from the second window part 23c, generation of bubbles in the adhesive 40 can be curbed.

In the optical connector 1A according to the present modified example, only the second window part 23c is formed to have a circular cross section, but the first window part 23a may similarly be formed to have a circular cross section. At this time, a diameter of the opening of the first window part 23a may be larger than a diameter of the opening of the second window part 23c.

### SECOND MODIFIED EXAMPLE

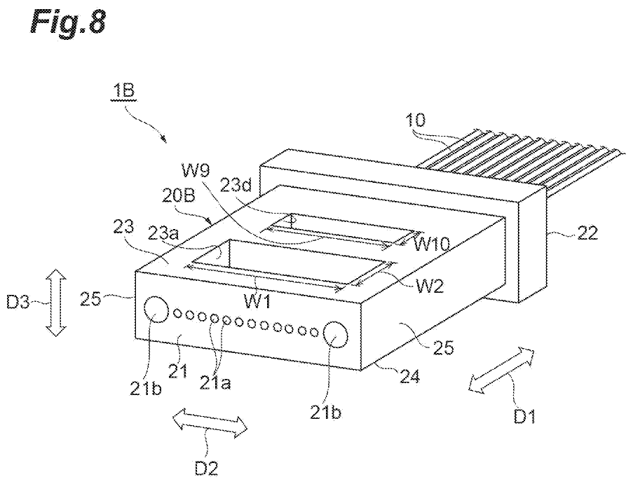

A second modified example of the optical connector 1 will be described with reference to FIG. 8. FIG. 8 is a perspective view illustrating an optical connector 1B according to the second modified example. In the following description, differences from the optical connector 1 according to the first embodiment described above in detail using FIGS. 1 to 4 will be mainly described, and description of common points may be omitted.

The optical connector 1B according to the second modified example includes a plurality of optical fibers 10 and a ferrule 20B that holds the plurality of optical fibers 10. The ferrule 20B includes a first window part 23a and a second window part 23d in an upper surface 23 thereof The first window part 23a according to the second modified example has the same configuration as the first window part 23a according to the first embodiment described above. On the other hand, the second window part 23d according to the second modified example differs from the second window part 23b according to the first embodiment in size of an opening width.

The second window part 23d according to the second modified example has an opening width W9 in a direction D2 and an opening width W10 in a direction D1. The second window part 23b is formed such that the opening width W9 in the direction D2 is larger than the opening width W10 in the direction D1. For example, the opening width W9 of the second window part 23d may be twice or more the opening width W10 in size. Also, the opening width W9 of the second window part 23d may be half or more the opening width W1 of the first window part 23a in size. Further, as in the second window part 23b according to the first embodiment, the second window part 23d according to the present modified example is connected to the first window part 23a through an accommodating part 30 inside the ferrule 20B. Also, the second window part 23d is formed at a position facing a plurality of guide grooves 31 (particularly, a plurality of second guide grooves 31c) provided on a fiber support surface 30d of the accommodating part 30, and thus at least a portion of the plurality of guide grooves 31 are visually noticeable through the second window part 23d.

In the optical connector 1B according to the present modified example, the opening width W9 of the second window part 23d in the direction D2 is formed larger than the opening width W10 in the direction D1. Therefore, the second window part 23d is formed to have a large opening width in the direction D2 in which the plurality of guide grooves 31 are aligned to be positioned over a large number of guide grooves 31. Thereby, visibility of the plurality of guide grooves 31 through the second window part 23d is improved, and the plurality of optical fibers 10 can be easily accommodated at appropriate positions in the ferrule 20B. Also, the first window part 23a is connected to the second window part 23d through the accommodating part 30. Thereby, for example, when an adhesive 40 for fixing the optical fibers 10 is injected into the accommodating part 30 through the first window part 23a, since air inside the accommodating part 30 is efficiently discharged from the second window part 23d having a large opening, generation of bubbles in the adhesive 40 can be curbed. Even after the adhesive 40 is injected, bubbles generated in the adhesive 40 can be easily removed through both the first window part 23a and the second window part 23d.

### THIRD MODIFIED EXAMPLE

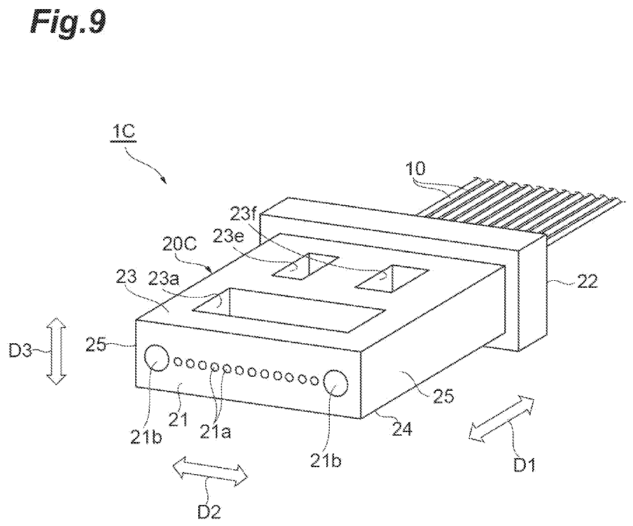

A third modified example of the optical connector 1 will be described with reference to FIG. 9. FIG. 9 is a perspective view illustrating an optical connector 1C according to the third modified example. In the following description, differences from the optical connector 1 according to the first embodiment described above in detail using FIGS. 1 to 4 will be mainly described, and description of common points may be omitted.

The optical connector 1C according to the third modified example includes a plurality of optical fibers 10 and a ferrule 20C that holds the plurality of optical fibers 10. The ferrule 20C includes a first window part 23a and a plurality of second window parts 23e and 23f on an upper surface 23 thereof The first window part 23a according to the third modified example has the same configuration as the first window part 23a according to the first embodiment described above. On the other hand, the number of the second window parts 23b has been one in the above-described first embodiment, but two second window parts 23e and 23f are provided in the third modified example.

The two second window parts 23e and 23f according to the third modified example are provided to be aligned in a direction D2. The two second window parts 23e and 23f have the same shape, and are formed to have a rectangular cross-sectional shape when it is taken along a plane in a directions D1 and the direction D2. Also, the two second window parts 23e and 23f are provided at positions symmetrical with respect to a central axis of the ferrule 20C in the direction D2 when viewed from the direction D3. Further, as in the second window part 23b according to the first embodiment, the two second window parts 23e and 23f according to the present modified example are connected to the first window part 23a through an accommodating part 30 inside the ferrule 20C. Also, the second window parts 23e and 23f are formed at positions facing a plurality of guide grooves 31 (particularly, a plurality of second guide grooves 31c) provided on a fiber support surface 30d of the accommodating part 30, and thus at least a portion of the plurality of guide grooves 31 are visually noticeable through the second window parts 23e and 23f.

In the optical connector 1C according to the present modified example, the plurality of second window parts 23e and 23f are provided. Thereby, since the guide grooves 31 are visually noticeable through each of the plurality of second window parts 23e and 23f, visibility of the plurality of guide grooves 31 is improved. Also, in the present modified example, since the plurality of second window parts 23e and 23f are provided to be aligned in the direction D2, a range of the plurality of guide grooves 31 that are visually noticeable through the second window parts 23e and 23f is expanded in the direction D2. Thereby, for example, even the plurality of guide grooves 31 positioned in the vicinity of a side surface 25 of the ferrule 20C are easily visually noticeable. Therefore, the plurality of optical fibers 10 can be easily accommodated at appropriate positions in the ferrule 20C. Also, the first window part 23a is connected to the plurality of second window parts 23e and 23f through the accommodating part 30. Thereby, for example, when an adhesive 40 for fixing the optical fibers 10 is injected into the accommodating part 30 through the first window part 23a, since air in the accommodating part 30 is efficiently discharged from the plurality of second window parts 23e and 23f, generation of bubbles in the adhesive 40 can be curbed. Even after the adhesive 40 is injected, bubbles generated in the adhesive 40 can be easily removed through the first window part 23a and the plurality of second window parts 23e and 23f.

Further, in the present modified example, the number of the second window parts 23e and 23f is two, but the number of the second window parts is not limited thereto, and may be three or more. Also, in the present modified example, the two second window parts 23e and 23f are provided at positions symmetrical with respect to the central axis of the ferrule 20C in the direction D2 when viewed from a direction D3, but may be provided at positions that are asymmetrical. For example, the second window part 23e on one side may be provided closer to a center of the ferrule 20C and the second window part 23f on the other side may be provided closer to the side surface 25.

### FOURTH MODIFIED EXAMPLE

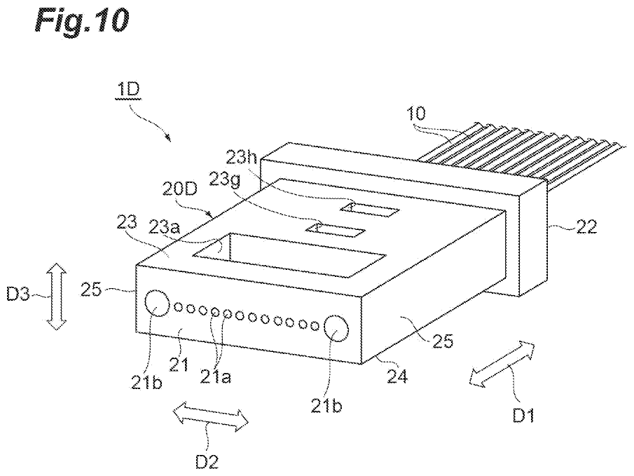

A fourth modified example of the optical connector 1 will be described with reference to FIG. 10. FIG. 10 is a perspective view illustrating an optical connector 1D according to the fourth modified example. In the following description, differences from the optical connector 1 according to the first embodiment described above in detail using FIGS. 1 to 4 will be mainly described, and description of common points may be omitted.

The optical connector 1D according to the fourth modified example includes a plurality of optical fibers 10 and a ferrule 20D that holds the plurality of optical fibers 10. The ferrule 20D includes a first window part 23a and a plurality of second window parts 23g and 23h on an upper surface 23 thereof. The first window part 23a according to the fourth modified example has the same configuration as the first window part 23a according to the first embodiment described above. On the other hand, the number of second window parts 23b has been one in the above-described first embodiment, but two second window parts 23g and 23h are provided in the fourth modified example.

Also, the two second window parts 23e and 23f according to the third modified example described above have been at the same position in a direction D1, but positions in the direction D1 of the two second window parts 23g and 23h according to the fourth modified example are different. Specifically, the second window part 23g on one side is provided closer to a first end surface 21 than the second window part 23h on the other side is. Also, the two second window parts 23g and 23h have the same position in the direction D2. That is, the two second window parts 23g and 23h are provided to be aligned in the direction D1. Further, as in the second window part 23b according to the first embodiment, the two second window parts 23g and 23h according to the present modified example are connected to the first window part 23a through an accommodating part 30 inside the ferrule 20D. Also, the second window parts 23g and 23h are formed at positions facing a plurality of guide grooves 31 (particularly, a plurality of second guide grooves 31c) provided on a fiber support surface 30d of the accommodating part 30, and thus at least a portion of the plurality of guide grooves 31 are visually noticeable through the second window parts 23g and 23h.

In the optical connector 1D according to the present modified example, the plurality of second window parts 23g and 23h are provided. Thereby, since the plurality of guide grooves 31 are visually noticeable through each of the plurality of second window parts 23g and 23h, visibility of the plurality of guide grooves 31 is improved. Also, in the present modified example, since the plurality of second window parts 23g and 23h are provided to be aligned in the direction D1, a range of the plurality of guide grooves 31 that are visually noticeable through the second window parts 23g and 23h is expanded in the direction D1. Thereby, for example, even the plurality of guide grooves 31 positioned in the vicinity of a second end surface 22 of the ferrule 20D are easily visually noticeable. Therefore, the plurality of optical fibers 10 can be easily accommodated at appropriate positions in the ferrule 20D. Also, the first window part 23a is connected to the plurality of second window parts 23g and 23h through the accommodating part 30. Thereby, for example, when an adhesive 40 for fixing the optical fibers 10 is injected into the accommodating part 30 through the first window part 23a, since air in the accommodating part 30 is efficiently discharged from the plurality of second window parts 23g and 23h, generation of bubbles in the adhesive 40 can be curbed. Even after the adhesive 40 is injected, bubbles generated in the adhesive 40 can be easily removed through the first window part 23a and the plurality of second window parts 23g and 23h.

Further, in the present modified example, the number of the second window parts 23g and 23h is two, but the number of the second window parts is not limited thereto, and may be three or more. Further, in the present modified example, the two second window parts 23g and 23h are positioned to be aligned in the direction D1, but positions of the second window parts 23g and 23h in the direction D2 may be different.

### FIFTH MODIFIED EXAMPLE

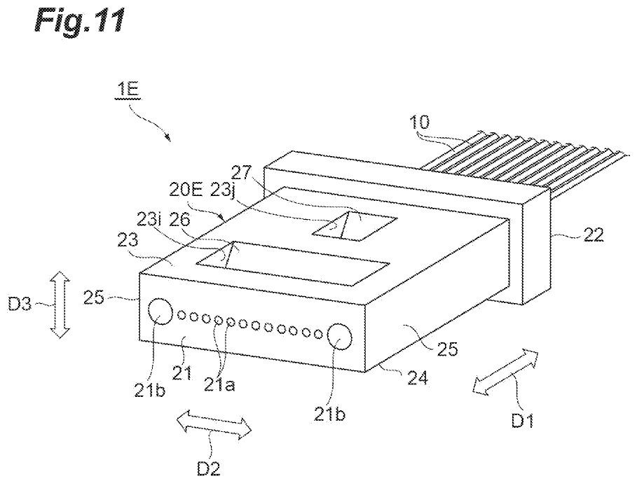

A fifth modified example of the optical connector 1 will be described with reference to FIG. 11. FIG. 11 is a perspective view illustrating an optical connector 1E according to the fifth modified example. In the following description, differences from the optical connector 1 according to the first embodiment described above in detail using FIGS. 1 to 4 will be mainly described, and description of common points may be omitted.

The optical connector 1E according to the fifth modified example includes a plurality of optical fibers 10 and a ferrule 20E that holds the plurality of optical fibers 10. The ferrule 20E includes a first window part 23i and a second window part 23j on an upper surface 23 thereof The first window part 23i and the second window part 23j according to the fifth modified example differ from the first window part 23a and the second window part 23b according to the first embodiment in that inner walls thereof have sloped surfaces 26 and 27.

The first window part 23i has the sloped surface 26. The sloped surface 26 is provided on a second end surface 22 side in the inner wall of the first window part 23i. The sloped surface 26 extends to approach a first end surface 21 side from the upper surface 23 toward a lower surface 24 of the ferrule 20. Since the first window part 23i has the sloped surface 26, an opening area of the first window part 23i on the upper surface 23 is larger than an opening area at an inner wall (an upper inner surface 30b) of an accommodating part 30.

Similarly to like the first window part 23i, the second window part 23j has the sloped surface 27. The sloped surface 27 is provided on the second end surface 22 side in the inner wall of the second window part 23j. The sloped surface 27 extends to approach the first end surface 21 side from the upper surface 23 toward the lower surface 24 of the ferrule 20. Since the second window part 23j has the sloped surface 27, an opening area of the second window part 23j at the upper surface 23 is larger than an opening area at the inner wall (the upper inner surface 30b) of the accommodating part 30. Further, as in the first window part 23a and the second window part 23b according to the first embodiment, the first window part 23i and the second window part 23j according to the present modified example are connected to each other via the accommodating part 30 inside the ferrule 20E. The first window part 23i and the second window part 23j are formed at positions facing a plurality of guide grooves 31 provided on a fiber support surface 30d of the accommodating part 30, and thus at least a portion of the plurality of guide grooves 31 are visually noticeable through the first window part 23i and the second window part 23j.

When an adhesive 40 is injected into the accommodating part 30, the adhesive 40 enters the first window part 23i and the second window part 23j from the opening at the upper inner surface 30b of the accommodating part 30 and moves to the opening on the upper surface 23 side. If an amount of the injected adhesive 40 is too much, there is a likelihood that the adhesive 40 will leak from the opening at the upper surface 23 to the outside of the ferrule 20E. In the optical connector 1E according to the present modified example, the opening areas of the first window part 23i and the second window part 23j on the upper surface 23 are respectively larger than the opening areas at the upper inner surface 30b of the accommodating part 30. In this case, since an amount of the adhesive 40 that can be held by the first window part 23i and the second window part 23j increases toward the upper surface 23 side, a moving speed of a surface of the adhesive 40 in the first window part 23i and the second window part 23j (a speed toward the opening at the upper surface 23) when the adhesive 40 is injected decreases gradually. Thereby, it is easy to adjust an injection amount of the adhesive 40 so that the adhesive 40 does not leak from the first window part 23i and the second window part 23j.

Also, the first window part 23i is connected to the second window part 23j through the accommodating part 30. Thereby, for example, when the adhesive 40 for fixing the optical fibers 10 is injected into the accommodating part 30 through the first window part 23i, since air inside the accommodating part 30 is discharged from the second window part 23j, generation of bubbles in the adhesive 40 can be curbed. Even after the adhesive 40 is injected, bubbles generated in the adhesive 40 can be easily removed through both the first window part 23i and the second window part 23j.

Further, in the present modified example, of the inner walls of the first window part 23i and the second window part 23j, the sloped surface is provided only at a portion on the second end surface 22 side, but the sloped surface may be provided at a portion on the other side.

### SIXTH MODIFIED EXAMPLE

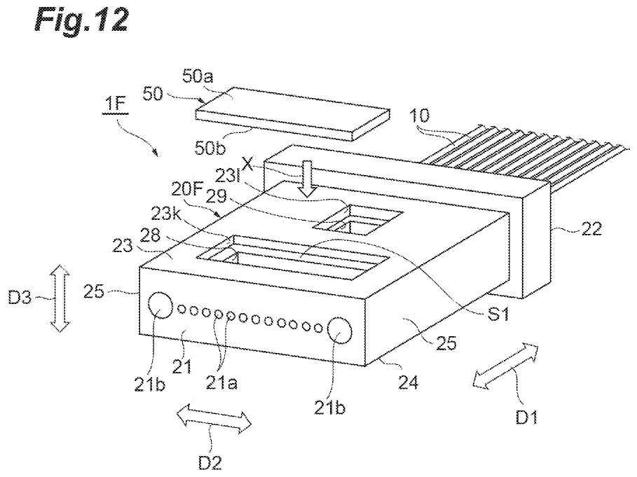

A sixth modified example of the optical connector 1 will be described with reference to FIG. 12. FIG. 12 is a perspective view illustrating an optical connector IF according to the sixth modified example. In the following description, differences from the optical connector 1 according to the first embodiment described above in detail using FIGS. 1 to 4 will be mainly described, and description of common points may be omitted.

The optical connector IF according to the sixth modified example includes a plurality of optical fibers 10 and a ferrule 20F that holds the plurality of optical fibers 10. The ferrule 20F includes a first window part 23k and a second window part 231 on an upper surface 23 thereof The first window part 23k and the second window part 231 according to the sixth modified example differ from the first window part 23a and the second window part 23b according to the first embodiment in that inner walls have steps 28 and 29, respectively. Also, the optical connector 1 includes a pressing part 50 that is fitted into the first window part 23k.

The first window part 23k has the step 28. The step 28 is provided over the entire inner circumference of the first window part 23k. Since the first window part 23k has the step 28, an opening of the first window part 23k at the upper surface 23 is larger than an opening at an inner wall (upper inner surface 30b) of an accommodating part 30. Also, the step 28 of the first window part 23k has a placement surface S1 on which an end portion of the pressing part 50 is placed. The placement surface S1 may extend flat in a direction D1 and a direction D2 to stably place the pressing part 50.

Similarly to the first window part 23k, the second window part 231 has the step 29. The step 29 is provided over the entire inner circumference of the second window part 231. Since the second window part 231 has the step 29, an opening of the second window part 231 at the upper surface 23 is larger than an opening at the inner wall (upper inner surface 30b) of the accommodating part 30.

The pressing part 50 is a member that presses the plurality of optical fibers 10 toward a plurality of guide grooves 31. The pressing part 50 is formed in a plate shape and has an upper surface 50a and a lower surface 50b opposing each other. The upper surface 50a and the lower surface 50b are formed flat. An area of each of the upper surface 50a and the lower surface 50b is smaller than an opening area of the first window part 23k on the upper surface 23 (a cross-sectional area of a portion above the step 28). Also, the pressing part 50 can be fitted inside the first window part 23k. An area of each of the upper surface 50a and the lower surface 50b is larger than an opening area of the first window part 23k at the upper inner surface 30b (a cross-sectional area of a portion below the step 28). Therefore, the pressing part 50 fitted in the first window part 23k is configured not to move toward the accommodating part 30 side from the step 28.

The pressing part 50 is fitted into the first window part 23k in a direction from the upper surface 23 to a lower surface 24 of the ferrule 20 (direction of arrow X illustrated in FIG. 12). Then, the end portion of the pressing part 50 is placed on the placement surface 51 of the step 28. When the pressing part 50 is fitted, the lower surface 50b of the pressing part 50 presses the adhesive 40, and the plurality of optical fibers 10 accommodated in the accommodating part 30 are pressed toward the plurality of guide grooves 31.

In the present modified example, since floating of the optical fibers 10 from the guide grooves 31 is suppressed by the pressing part 50, a positional deviation of the optical fibers 10 can be prevented. Also, in the present modified example, as in the fifth modified example described above, opening areas of the first window part 23k and the second window part 231 on the upper surface 23 are respectively larger than opening areas at the upper inner surface 30b of the accommodating part 30. Thereby, it easy to adjust an injection amount of the adhesive 40 so that the adhesive 40 does not leak from the first window part 23k and the second window part 231.

Also, the first window part 23k is connected to the second window part 231 through the accommodating part 30. Thereby, for example, when the adhesive 40 for fixing the optical fibers 10 is injected from the first window part 23k into the accommodating part 30, since air inside the accommodating part 30 is discharged from the second window part 231, generation of bubbles in the adhesive 40 can be curbed. Even after the adhesive 40 is injected, bubbles generated in the adhesive 40 can be easily removed through both the first window part 23k and the second window part 231.

While the embodiments of the present disclosure have been described in detail above, the present disclosure is not limited to the above-described embodiments and can be applied to various embodiments.

For example, shapes of the first window part 23a and the second window part 23b are not limited to the shapes described above. Specifically, cross-sectional shapes in the direction D1 and the direction D2 of the first window part 23a and the second window part 23b may be square or trapezoidal. Also, the first window part 23a and the second window part 23b may be provided not only at the upper surface 23 but also at the side surface 25. Further, the first window part 23a and the second window part 23b may be provided at different surfaces. Specifically, the first window part 23a may be provided at the upper surface 23 and the second window part 23b may be provided at the side surface 25. Also, in the present embodiment, at least a portion of the plurality of guide grooves 31 are visually noticeable from both the first window part 23a and the second window part 23b, but at least a portion of the plurality of guide grooves 31 need only be visually noticeable from at least the first window part 23a, and may not be visually noticeable from the second window part 23b.

### REFERENCE SIGNS LIST

1, 1A, 1B, 1C, 1D, 1E, 1F Optical connector
10 Optical fiber
11 Coated portion
12 Coating-removed portion
20, 20A, 20B, 20C, 20D, 20E, 20F Ferrule
21 First end surface
21a Through hole
21b Guide hole
22 Second end surface
22a Opening
23 Upper surface
23a, 23i, 23k First window part
23b, 23c, 23d, 23e, 23f, 23g, 23h, 23j, 231 Second window part
24 Lower surface
25 Side surface
26 Sloped surface
27 Sloped surface
28 Step
29 Step
30 Accommodating part
30a Distal end side inner surface
30b Upper inner surface
30c Lower inner surface
30d Fiber support surface
30e Step
31 Guide groove
31a First guide groove
31b Tapered groove
31c Second guide groove
40 Adhesive
50 Pressing part
50a Upper surface
50b Lower surface
51 Placement surface

1. A ferrule comprising:
a first end surface and a second end surface provided opposite to each other in a first direction;
an outer surface provided between the first end surface and the second end surface;
an accommodating part opening at the second end surface and configured to be able to accommodate a plurality of optical fibers therein;
a plurality of guide grooves configured to determine a position and a direction of each of the plurality of optical fibers in the accommodating part, the plurality of guide grooves being provided to each extend in the first direction on an inner wall of the accommodating part and be aligned in a second direction intersecting the first direction; and
a first window part and a second window part opening at the outer surface and connected to each other through the accommodating part,
wherein the first window part is positioned on the first end surface side with respect to the second window part, and the first window part is provided at a position through which at least a portion of the guide grooves are visually noticeable.

2. The ferrule according to claim 1, wherein an opening area of the second window part on the outer surface is smaller than an opening area of the first window part on the outer surface.

3. The ferrule according to claim 1, wherein an opening width of the first window part on the outer surface in the second direction is larger than a width of a groove region in which the plurality of guide grooves are formed on the inner wall of the accommodating part in the second direction.

4. The ferrule according to claim 1, wherein an opening width of the first window part on the outer surface in the second direction is larger than an opening width of the first window part on the outer surface in the first direction.

5. The ferrule according to claim 1, wherein at least one of a step and a sloped surface is formed on an inner wall of the first window part so that an opening area of the first window part on the outer surface is larger than an opening area of the first window part at the inner wall of the accommodating part.

6. The ferrule according to claim 1, wherein the second window part includes a plurality of window parts opening at the outer surface and connected to the accommodating part.

7. An optical connector comprising:
the ferrule according to claim 1;
a plurality of optical fibers accommodated in the accommodating part of the ferrule along the plurality of guide grooves; and
an adhesive injected into the accommodating part through the first window part to fix the plurality of optical fibers to the inner wall of the accommodating part.

8. The optical connector according to claim 7, further comprising a pressing part positioned inside the first window part and configured to press the plurality of optical fibers toward the plurality of guide grooves.

9. A method for manufacturing an optical connector including the ferrule according to claim 1, the method comprising:
accommodating a plurality of optical fibers in the accommodating part of the ferrule along the plurality of guide grooves; and
injecting an adhesive for fixing the plurality of optical fibers to the inner wall of the accommodating part into the accommodating part through the first window part,
wherein in the injecting, the adhesive is injected at least up to a region of the accommodating part which is visually noticeable through the second window part.
